(19) United States
(12) Patent Application Publication
(10) Pub. No.: US 2016/0004940 A1
(43) Pub. Date: Jan. 7, 2016

(54) IMAGE PROCESSING APPARATUS AND METHOD FOR CONTROLLING THE IMAGE PROCESSING APPARATUS

(71) Applicant: CANON KABUSHIKI KAISHA, Tokyo (JP)

(72) Inventor: Tateki Narita, Tokyo (JP)

(21) Appl. No.: 14/755,288

(22) Filed: Jun. 30, 2015

(30) Foreign Application Priority Data
Jul. 7, 2014 (JP) 2014-139819

(51) Int. Cl. G06K 15/02

(52) U.S. Cl. CPC G06K 15/1809; G06K 15/1886

(57) ABSTRACT

An information processing apparatus controlling a printing of multiple copies includes: a comparison unit which compares an image generation processing period of the image data with a processing period threshold; and a control unit which controls the image data of a page in which the image generation processing period is shorter than the processing period threshold as a result of the comparison by the comparison unit, so as to be deleted after the page of the first copy has been printed, and which controls the image data of a page in which the image generation processing period is the processing period threshold or longer, so as to be saved even after the page of the first copy has been printed.

### BACKGROUND OF THE INVENTION

1. Field of the Invention

The present invention relates to an image processing apparatus, and a method for controlling the same.

2. Description of the Related Art

In the case where multiple copies of input data having a plurality of pages are printed in a printing function of an image processing apparatus, there is a technology of controlling sort printing which outputs images, copy by copy, in an order of pages.

The sort printing control needs to print image data corresponding to the copies. In a host rendering, a PC side which supplies a printing job to the image processing apparatus controls the sort printing, generates the image data corresponding to the copies, and transmits the generated image data to the image processing apparatus. On the other hand, in a device rendering, the image processing apparatus controls the sort printing, receives input data corresponding to one copy, generates the image data, and executes the printing of the image data corresponding to the copies.

In the host rendering in which the PC side controls the sort printing, a dedicated printer driver which is provided with the function is prerequisite. However, in a recent market, such a use case becomes general as to print the image data sent from a general-purpose printer driver independent of a functional difference among image processing apparatuses, or as to directly receive an input file such as a PDF sent from the PC side and print the received input file; and the control of the device rendering is required.

In the device rendering, the image processing apparatus receives vector data as input data, which is stored in a page description language (PDL), generates image data from the vector data, and prints the generated image data.

There are roughly two methods in the sort printing control in the device rendering. The first method is a method (image storage system) of saving the image data which has been converted when the first copy has been printed, and using the saved image data also in printing after the second copy. The second method is a method (image generating system) of deleting the image data after each page has been printed, generating image data from the vector data also in printing after the second copy, and printing the generated image data. In Japanese Patent Application Laid-Open No. 2010-282280, such a technology is presented as to change the method when storage capacity for saving the image data therein becomes insufficient.

### SUMMARY OF THE INVENTION

The sort printing control in the device rendering has problems with memory efficiency and printing speed performance.

In the image storage system, large-capacity storage is necessary for saving the image data, which causes poor memory efficiency, and an image processing apparatus with small-capacity storage has a possibility of being incapable of achieving the sort printing due to insufficient capacity. Even when the capacity is not insufficient, the image processing apparatus has a problem of shortage of memory to be used in other processings and other functions and being unable to provide a sufficient function to a user. The other processing is, for instance, a secure printing function which is such a function that the image processing apparatus saves image data provided with a password in the apparatus, and executes printing based on a subsequent input of the password and a subsequent indication to execute printing. The other function is, for instance, a scanning function which is such a function that the image processing apparatus provided with a read-out apparatus performs an operation of reading out a document in parallel to a printing function, saves the read out image data in the apparatus and transmits the read out image data to an external apparatus.

The image generating system has a possibility of lowering the printing speed performance because of generating image data of all pages also in printing after the second copy, and has a problem of decrease in the printing speed performance in every copy when there exists a page which takes time for the processing of generating the image data.

According to an aspect of the present invention, an image processing apparatus enabling a printing of multiple copies of data having a plurality of pages comprises: an image generating unit configured to generate an image based on the data; a storage unit configured to store the image generated by the image generating unit; a printing unit configured to print the image generated by the image generating unit, copy by copy, in an order of pages; and a controlling unit configured to determine, page by page, during a printing of a first copy, as to whether the image generated by the image generating unit is to be retained in the storage unit for use in printing a second copy, or is to be re-generated by the image generating unit for use in printing the second copy.

According to the present invention, the image processing apparatus avoids the decrease in the printing speed performance, which occurs after the second copy of the sort printing, and also can reserve memory which is used in other processings and other functions, by optimizing the memory efficiency of the image data to be saved.

Further features of the present invention will become apparent from the following description of exemplary embodiments with reference to the attached drawings.

### BRIEF DESCRIPTION OF THE DRAWINGS

FIG. 1 is a view illustrating one example of a hardware configuration of an image processing apparatus.

FIG. 2 is a view illustrating an example of a control sequence concerning a printing function of the image processing apparatus.

FIG. 3 is a view illustrating one example of sort printing 1 in a device rendering.

FIG. 4 is a view illustrating one example of sort printing 2 in the device rendering.

FIG. 5 is a view illustrating one example of image data save control processing.

FIG. 6 is a view illustrating one example of a printing period situation in the sort printing.

FIG. 7 is a view illustrating an example of a memory situation by the image data save control processing.

FIG. 8 is a flow chart illustrating one example of the image data save control processing.

### DESCRIPTION OF THE EMBODIMENTS

Preferred embodiments of the present invention will now be described in detail in accordance with the accompanying drawings.

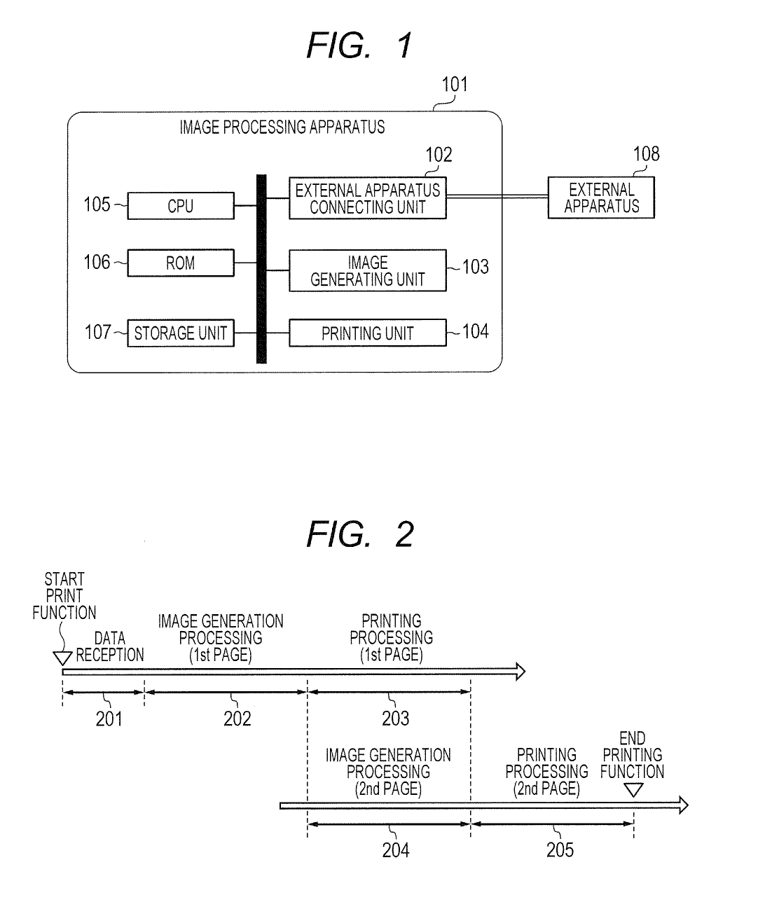

FIG. 1 is a view illustrating one example of a hardware configuration of an image processing apparatus.

The image processing apparatus 101 includes, an external apparatus connecting unit 102, an image generating unit 103, a printing unit 104, a CPU 105, a ROM 106 and a storage unit 107, as a hardware configuration.

The external apparatus connecting unit 102 communicates with an external apparatus, and transmits and receives input data for printing, through a LAN or a USB. The image generating unit 103 subjects the input data which the external apparatus connecting unit 102 has acquired to predetermined image processing such as color space conversion and color concentration conversion, and generates image data. The printing unit 104 prints the image data which has been generated in the image generating unit 103, on a paper medium or the like. The CPU 105 is a controlling unit of the image processing apparatus 101, and controls the whole apparatus. On the ROM 106, a control program of the CPU 105, and the like, are installed. The storage unit 107 is a volatile memory on which a variable of a control program of the CPU 105, and the image data, are installed.

The CPU 105 executes processing based on the programs which are stored in the ROM 106 or the storage unit 107, and thereby the function of the image processing apparatus, which will be described later, and the processing of a flow chart, which will be described later, are achieved.

The image processing apparatus is one example of an information processing apparatus which controls a printing of multiple copies.

FIG. 2 is a view illustrating an example of a control sequence concerning a printing function of the image processing apparatus.

Here, suppose that data to be printed consists of two pages. In data reception 201, the image processing apparatus 101 receives data to be printed from the external apparatus connecting unit 102, and saves the received data to be printed, in the storage unit 107. In image generation processing 202, the image processing apparatus 101 makes the image generating unit 103 generate image data of the first page of the data to be printed, and transmits the generated image data to the printing unit 104. In printing processing 203, the image processing apparatus 101 prints the image data which has been transmitted to the printing unit 104. In addition, after the end of the image generation processing 202, the image processing apparatus 101 similarly executes image generation processing 204 and printing processing 205 of the second page in parallel to the printing processing 203.

In the image generation processing 204, when a time period of the image generation processing is short and the processing ends before the printing processing 203 ends, the printing processing 205 is executed after the end of the printing processing 203. In this case, the printing processing 203 and the printing processing 205 are successively performed, accordingly the printing performance is not lowered, and the image data can be printed at high speed.

On the other hand, when a time period of the image generation processing is long in the image generation processing 204, and the processing ends after the printing processing 203 has ended, the printing processing 205 is executed after the end of the image generation processing 204. In this case, there is a time interval between the printing processing 203 and the printing processing 205, and accordingly the printing performance is lowered. In other words, when there exists a page which needs a longer period of time for the image generation processing than the printing processing, the printing performance results in being lowered.

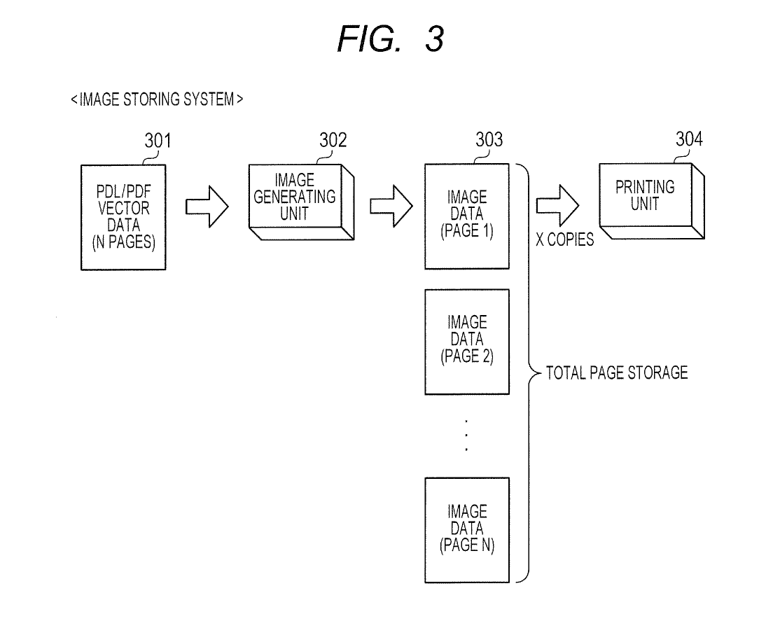

FIG. 3 is a view illustrating one example of sort printing 1 (image storage system) in a device rendering.

Vector data 301 is page description language (PDL) data or a PDF file which the image processing apparatus 101 has received from the external apparatus. An image generating unit 302 is the image generating unit 103 in FIG. 1. The image generating unit 302 generates image data 303 from the vector data 301. Here, the image generating unit 302 generates the image data 303 of all pages corresponding to one copy, and saves the generated image data in the storage unit 107. A printing unit 304 is the printing unit 104 in FIG. 1. The printing unit 304 prints the image data 303. Here, the printing unit 304 does not delete the image data 303 from the storage unit 107 even after the printing, prints the image data with reference to the image data 303 in every copy, and deletes the image data 303 after the printing of all the copies has been completed. In the printing of the first copy, the image generating unit 302 and the printing unit 304 operate in parallel; and accordingly if there is a page in which the image data 303 is generated slowly, the processing of the printing unit 304 is kept waiting, and the printing speed performance is lowered. However, in printing after the second copy, the image generating unit 302 does not need to generate the image, and accordingly the decrease in the performance does not occur in printing in the printing unit 304. However, the above example is predicated on that the image data 303 of all the pages is saved in the storage unit 107, and the image processing apparatus of which the storage unit 107 has small capacity cannot achieve the sort printing. In addition, even in the case where the lack of the capacity does not occur, there is the case where the memory to be used therefor is large and reduces a memory capacity to be used for other processings and other functions, and the image processing apparatus cannot provide a sufficient function as a whole.

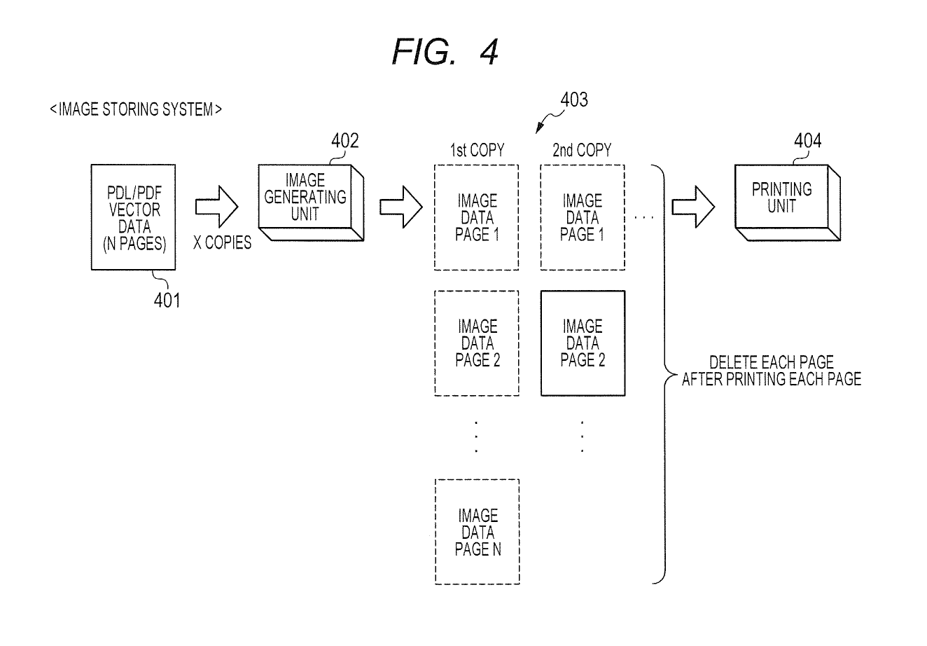

FIG. 4 is a view illustrating one example of sort printing 2 (image generating system) in the device rendering.

Vector data 401 is page description language (PDL) data or a PDF file which the image processing apparatus 101 has received from the external apparatus. An image generating unit 402 is the image generating unit 103 in FIG. 1. The image generating unit 402 generates image data 403 corresponding to all the copies from the vector data 401, and saves the generated image data in the storage unit 107. A printing unit 404 is the printing unit 104 in FIG. 1. The printing unit 404 sequentially prints the image data 403, and thereby the sort printing is achieved. Here, the image generating unit 402 saves the image data 403 in the storage unit 107 once, but the printing unit 404 operates in parallel and deletes the image data of each page after the printing of each of the pages has been completed. Accordingly, the storage unit 107 may have a capacity for saving the image data of at least one page therein. However, the image generating unit 402 needs to generate the image also in printing after the second copy, and if there is a page in which the image data 403 is generated slowly, there is the case where the processing of the printing unit 404 is kept waiting, and the printing speed performance is lowered.

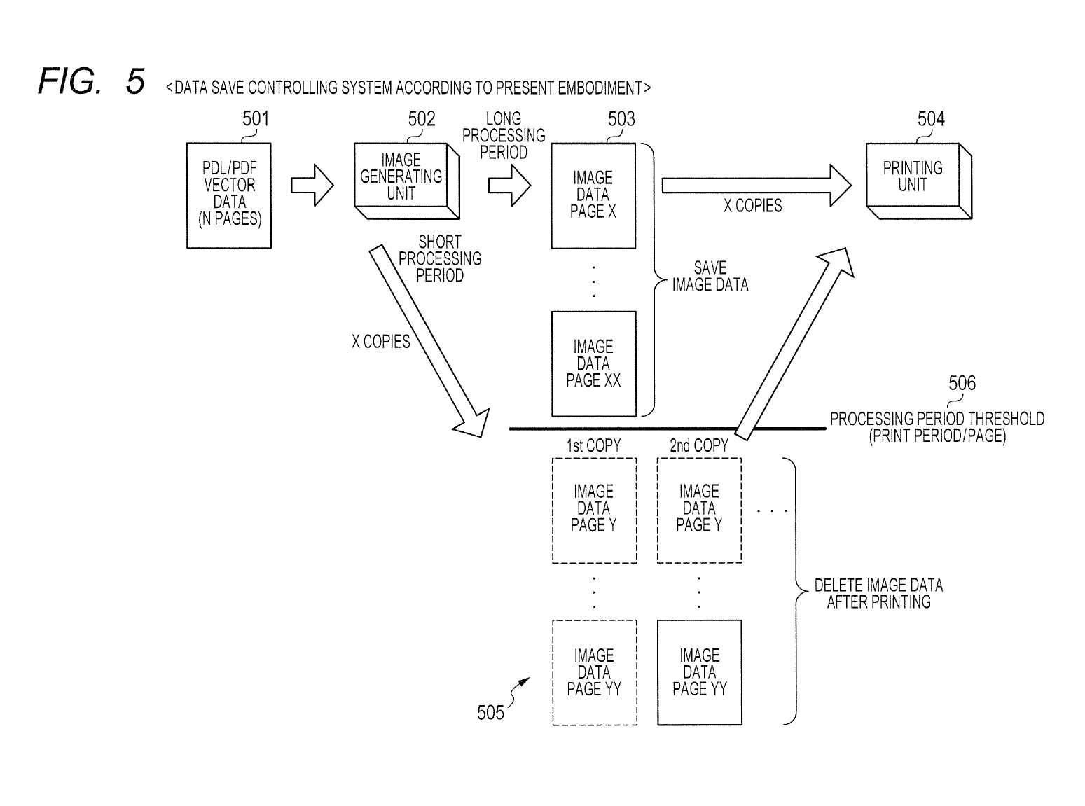

FIG. 5 is a view illustrating one example of image data save control processing depending on an image generation processing period and a processing period threshold.

Vector data 501 is page description language (PDL) data and a PDF file which the image processing apparatus 101 has received from an external apparatus. An image generating unit 502 is the image generating unit 103 in FIG. 1. The image generating unit 502 measures an image generation processing period of each page, when generating image data from the vector data 501, in the generation of the image data of the first copy. Here, the image generating unit 502 compares the image generation processing period of each of the pages with the processing period threshold 506. Then, the image generating unit 502 saves a page of which the image generation processing period is the processing period threshold 506 or longer (processing period threshold or longer), as image data 503, and saves a page of which the image generation processing period is shorter than the processing period threshold 506, as image data 505. A printing unit 504 is the printing unit 104 in FIG. 1. When printing the page of the image data 503, the printing unit 504 does not delete the image data of the page from the storage unit 107 even after the printing has been completed, and when printing the page of the image data 505, the printing unit 504 deletes the image data of the page from the storage unit 107 after the printing has been completed. The image generating unit 502 does not generate the image of the image data 503 which has been saved in the storage unit 107, in the generation of the image data after the second copy, and generates the image of the image data 505 which has been deleted and has not been saved after the printing. The processing period threshold 506 is a printing period which the printing unit 504 needs for printing one page, and becomes a threshold that is used when the CPU 105 determines which of the image generating unit 502 and the printing unit 504 finishes the processing earlier. The printing period of the printing unit 504 varies depending on the size of the image data of each of the pages, and on the type of the paper to be printed thereon. Because of this, the value of the processing period threshold 506 may be determined for each of the pages, or a consistent value such as an average time period and a minimum time period may be determined for all of the pages.

The image data save control processing according to the above described image generation processing period and processing period threshold saves only a page in which the image is generated slowly and the printing unit 504 is kept waiting in printing after the second copy, in the storage unit 107, as the image data 503. Accordingly, the image processing apparatus does not cause the decrease in the printing speed performance, and besides can sufficiently reserve memory which is used in other processings and other functions, by minimizing the capacity of the memory to be used.

In addition, the external apparatus 108 may be configured so as to perform the image data save control processing which the image processing apparatus 101 performs in FIG. 5. The external apparatus 108 has at least a unit to be connected with the image processing apparatus 101, a CPU and a storage unit, as a hardware configuration. Then, the CPU of the external apparatus 108 performs processing based on a program which is stored in the storage unit of the external apparatus 108, and thereby a function and the like of the external apparatus 108 are achieved, which will be described later.

The external apparatus 108 adopts a method (host rendering) of generating image data corresponding to the copies and transmitting the generated image data to the image processing apparatus 101. For instance, the external apparatus 108 measures the processing period spent when having generated the image data of the first copy, and when the measured processing period is longer than the processing period threshold, the external apparatus 108 saves the image data in the inner part of the apparatus, does not generate the image data after the second copy, and transmits the saved image data to the image processing apparatus 101. Here, the external apparatus 108 acquires each of the time when the image generation processing period starts and the time when the image generation processing period ends, from the image processing apparatus 101, calculates a difference between the times, and thereby measures the image generation processing period. Alternatively, the external apparatus 108 may acquire the image generation processing period which the image processing apparatus 101 has measured, from the image processing apparatus 101. In addition, the external apparatus 108 may also acquire information on the capability of the printing unit 104 from the image processing apparatus 101, calculate a printing period based on the above described information on the capability and information on the print setting of the image data which has been transmitted to the image processing apparatus 101, and determine the processing period threshold.

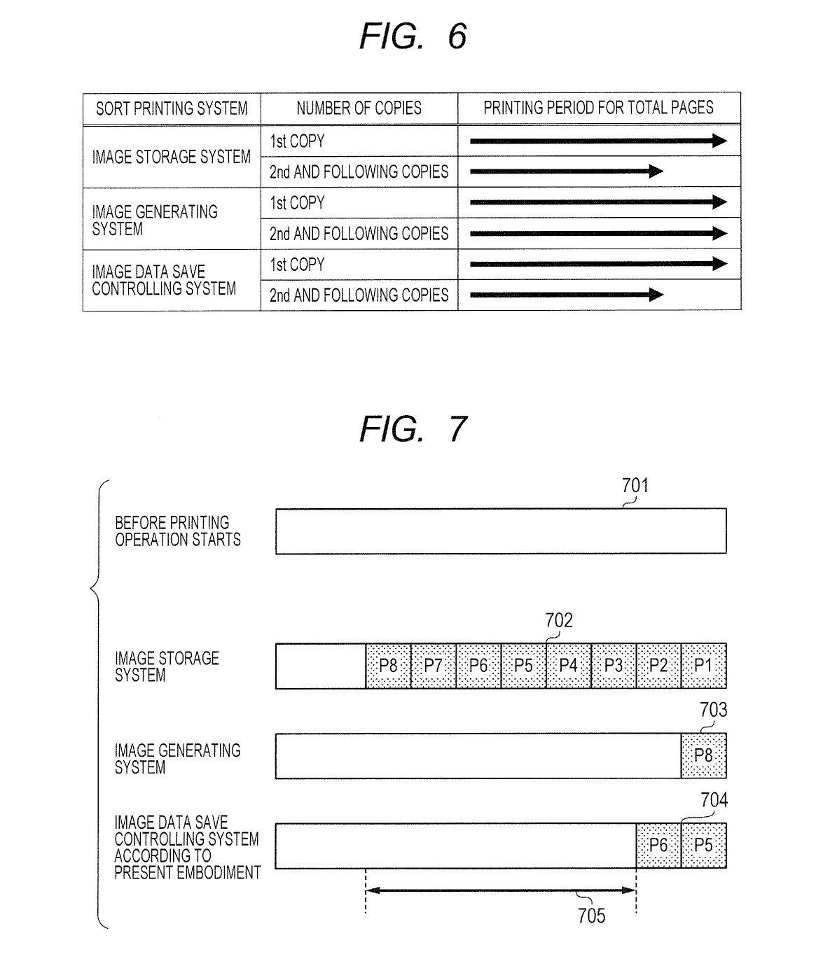

FIG. 6 is a view illustrating one example of a printing period situation in the sort printing. In FIG. 6, the printing periods of the first copy and all of the pages after the second copy are compared with each other, which have been described in the image storage system illustrated in FIG. 3, the image generating system illustrated in FIG. 4 and the image data save controlling system of the present embodiment illustrated in FIG. 5.

In the image storage system, the saved image data is used in printing after the second copy, and the image is not generated; and accordingly, after the second copy, the decrease in the performance of the printing speed does not occur, and the printing period is shortened compared to that of the first copy. However, in the image storage system, the image data of all the pages is saved, and accordingly an amount of the memory to be used therefor becomes large.

The image generating system generates the image data of all the pages also after the second copy similarly to the first copy, and accordingly needs the same printing period as in the first copy also after the second copy.

On the other hand, in the method of the present embodiment, the image data is saved which needs a longer period of time for the generation of the image than the printing period of each of the pages, and accordingly the decrease in the printing speed performance does not occur after the second copy, similarly to the performance in the image storage system, and the printing period is shortened compared to that in the first copy. In addition, the image data to be saved is limited to the image data which needs a long period of time for the generation of the image, and accordingly the amount of the memory to be used decreases (becomes small) compared to that in the image storage system.

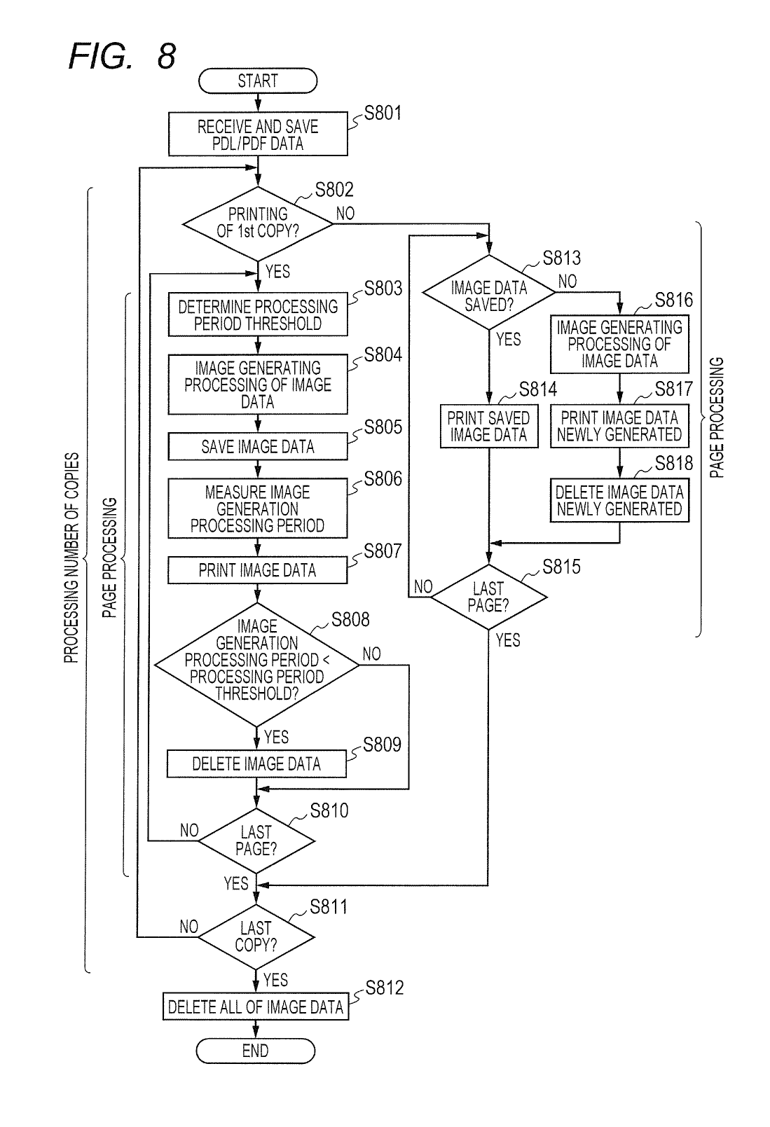

FIG. 7 is a view illustrating an example of a memory situation according to the image data save control processing.

In FIG. 7, the situations of a used memory after the operations are compared with each other, which are described in the image storage system illustrated in FIG. 3, the image generating system illustrated in FIG. 4 and the image data save controlling system of the present embodiment illustrated in FIG. 5.

A memory situation 701 shows the situation of the storage unit 107 before a printing operation starts, and all the memory is unused. For instance, suppose that the image processing apparatus 101 receives vector data of all of eight pages, and the fifth page and the sixth page need a longer period of time for the generation of the image than the printing periods of each of the pages.

The image storage system saves the image data of all of the eight pages, and accordingly as for the memory situation after the operation, the memory corresponding to the image data for all of the eight pages becomes a used state, as is illustrated in a memory situation 702.

The image generating system does not save the image data of each of the pages after printing, and accordingly only a page which is being printed becomes a used state, as is illustrated in a memory situation 703. The image generating system uses a small amount of the memory, but needs to generate the images of the fifth page and the sixth page every time also after the second copy, which need a long period of time for the generation of the image, and the printing performance is lowered.

On the other hand, in the method of the present embodiment, only the image data is saved which needs a longer period of time for the generation of the image than the printing period of each of the pages, accordingly only the fifth page and the sixth page are in a used state, as is illustrated in a memory situation 704, and there is a surplus by a difference 705, compared to that of the image storage system. Furthermore, the image data of the fifth page and the sixth page are saved, which need a long period of time for the generation of the image, and accordingly the image data can be printed at high speed also after the second copy, compared to that in the image generating system.

FIG. 8 is a flow chart illustrating one example of the image data save control processing.

The CPU 105 receives vector data such as a page description language (PDL) data and a PDF file from the external apparatus connecting unit 102, and saves the received vector data in the storage unit 107 (S801). The CPU 105 determines whether the indication is the printing of the first copy, or not (S802).

In the printing of the first copy, the CPU 105 determines the printing period needed for the printing of one page (processing period threshold) (S803). More specifically, the CPU 105 calculates a printing period based on the information on the capability of the printing unit 104 and the information on the print setting of the data which the CPU 105 has received from the external apparatus 108 or the like, and determines the printing period needed for the printing of one page (processing period threshold). Here, the printing period needed for the printing of one page varies depending on the size of the image data of each of the pages, and on the type of the paper to be printed thereon. Because of this, the CPU 105 may determine the printing periods for each of the pages, and may determine the consistent value such as the average time period and the minimum time period for all of the pages. For instance, in the case where the printing unit 104 has a performance of 30 pages/minute when printing an A4 size, and the printing of the A4 size is specified in the information on the print setting of the image data which has been transmitted from the external apparatus 108, the CPU 105 determines that the processing period threshold is 2 seconds, which is the consistent value for all of the pages. Here, when amount of capacity space of the memory (or storage) which saves the image data therein becomes less than a set value, the CPU 105 may change the printing period (processing period threshold) which has been determined in the step S803 to a longer period (for instance, from 2 seconds to 3 seconds). Thereby, the amount of the image data to be saved can be reduced. In addition, the CPU 105 may change the above described set value according to operation information sent through an operation unit of the image processing apparatus 101, and the like, or according to a command to change the set value sent from the external apparatus 108, and the like.

Next, the CPU 105 generates image data from the vector data which the CPU 105 has received in the step S801 (S804). The CPU 105 saves the generated image data in the storage unit 107 (S805). The CPU 105 measures the image generation processing period which has been needed in the image generation processing (S806). The CPU 105 measures the image generation processing period in the step S806, by recording each of the time when the image generation processing period starts and the time when the image generation processing period ends, and calculating the difference between the times. Then, the CPU 105 prints the generated image data (S807).

The CPU 105 compares values between the processing period threshold which has been determined in the step S803 and the image generation processing period which has been measured in the step S806 (S808). When the image generation processing period is shorter than the processing period threshold, the CPU 105 deletes the image data (S809), and proceeds to a step S810. On the other hand, when the image generation processing period is the processing period threshold or longer, the CPU 105 omits the processing in the step S809, and proceeds to the step S810. In the step S810, the CPU 105 determines whether the page is the last page of each copy, or not. When the page is not the last page, the CPU 105 returns to the step S803, and when the page is the last page, the CPU 105 proceeds to a step S811. In the step S811, the CPU 105 determines whether the copy is the last copy, or not. When the copy is the last copy, the CPU 105 proceeds to a step S812, and when the copy is not the last copy, the CPU 105 returns to the step S802.

In the step S812, the CPU 105 deletes all of the saved image data.

On the other hand, in the step S813, the CPU 105 determines whether the image data of the page to be processed is saved in the storage unit 107, or not. Specifically, the CPU 105 determines whether the image data of the page to be processed is saved in the storage unit 107 or not, in printing after the second copy. When the image data of the page to be processed is saved in the storage unit 107, the CPU 105 proceeds to a step S814, and when the image data of each of the pages is not saved in the storage unit 107, the CPU 105 proceeds to a step S816.

In the step S814, the CPU 105 prints the saved image data. On the other hand, in the step S816, the CPU 105 generates image data from the vector data which the CPU 105 has received in the step S801 and has saved in the storage unit 107, and saves the generated image data in the storage unit 107.

The CPU 105 prints the image data which the CPU 105 has newly generated in the step S816 (S817). After printing, the CPU 105 deletes the above described image data (S818), and proceeds to a step S815.

In the step S815, the CPU 105 determines whether the page is the last page of each copy, or not. When the page is not the last page, the CPU 105 returns to the step S813, and when the page is the last page, the CPU 105 proceeds to a step S811.

As has been described in the above embodiment, the processing of the present embodiment has effects of avoiding the decrease in the printing speed performance, which occurs after the second copy of the sort printing, and also being capable of ensuring a memory which is used in other processings and other functions, by optimizing the memory efficiency of the image data to be saved.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-139819, filed Jul. 7, 2014, which is hereby incorporated by reference herein in its entirety.

What is claimed is:

1. An image processing apparatus enabling a printing of multiple copies of data having a plurality of pages comprising:
an image generating unit configured to generate an image based on the data;
a storage unit configured to store the image generated by the image generating unit;
a printing unit configured to print the image generated by the image generating unit, copy by copy, in an order of pages; and
a controlling unit configured to determine, page by page, during a printing of a first copy, as to whether the image generated by the image generating unit is to be retained in the storage unit for use in printing a second copy, or is to be re-generated by the image generating unit for use in printing the second copy.

2. The image processing apparatus according to claim 1, wherein,
when the controlling unit determined such that the image generated by the image generating unit is to be re-generated by the image generating unit for use in printing the second copy, the controlling unit removes the image generated by the image generating unit for use in printing the first copy and stored in the storage unit, after the printing by the printing unit.

3. The image processing apparatus according to claim 1, wherein,
when a period for generating the image of a page by the image generating unit is shorter than a threshold, the controlling unit removes the image of the page from the storage unit.

4. The image processing apparatus according to claim 3, wherein
the threshold is determined based on a kind of paper.

5. The image processing apparatus according to claim 3, wherein
the threshold is determined based on a size of the data.

6. The image processing apparatus according to claim 3, wherein
the threshold is determined based on a printing capacity of the printing unit.

7. The image processing apparatus according to claim 3, wherein
the threshold is changed according to amount of capacity space of the storage unit.

8. The image processing apparatus according to claim 1, wherein
the data is stored in a page description language.

9. The image processing apparatus according to claim 1, wherein,
the controlling unit removes the image stored in the storage unit, after printing of the last copy.

10. A controlling method of an image processing apparatus for enabling a printing of multiple copies of data having a plurality of pages comprising:
generating an image based on the data;
storing the image generated in the generating the image;
printing the image generated by the generating the image, copy by copy, in an order of pages; and
controlling to determine, page by page, during a printing of a first copy, as to whether the image generated in the generating the image is to be retained for use in printing a second copy, or is to be re-generated by the generating the image for use in printing the second copy.
